(19) United States
(12) Patent Application Publication
(10) Pub. No.: US 2017/0060280 A1
(43) Pub. Date: Mar. 2, 2017

(54) TOUCH DEVICE WITH ENHANCED PROTECTION EFFECT THEREON

(71) Applicant: LIYITEC INCORPORATED, Taoyuan City (TW)

(72) Inventor: Shu-Chen HSU, TAOYUAN CITY (TW)

(73) Assignee: LIYITEC INCORPORATED, TAOYUAN CITY (TW)

(21) Appl. No.: 15/060,922

(22) Filed: Mar. 4, 2016

(30) Foreign Application Priority Data
Aug. 28, 2015 (TW) 104214044

(51) Int. Cl. G06F 3/041

(52) U.S. Cl. CPC G06F 3/041; G06F 2203/04103

(57) ABSTRACT

A touch device with enhanced protection effect thereon includes a touch assembly, a protection layer and a transparent layer. After the protection layer is painted on the touch assembly, the transparent layer is formed on the protection layer. The protection layer is transparent and anti-ultraviolet and protects the touch device against the aging arising from exposure to ultraviolet light. The transparent layer has a high hardness. Accordingly, durability and production yield of the touch device can thus be enhanced.

### BACKGROUND OF THE INVENTION

1. Field of the Invention

The present invention relates to a touch device and, more particularly, to a touch device with enhanced protection effect thereon.

2. Description of the Related Art

The advancement of semiconductor fabrication technology has quickly migrated the display device from the display screens back in early days to the touch devices and small-size touch devices applied to current personal mobile devices, allowing the mobile devices to be accompanied with people from all walks of life and used everywhere in the world for betterment of convenience and entertainment in daily life.

Conventional touch devices have been extensively applied to all fields including public equipment and transportation tools. Usually, public equipment has stricter requirements against weather effect than private equipment, especially for outdoor use, because the touch devices sometimes become uncontrollable due to variation in temperature. A countermeasure to the weather effect is to attach a window film on a touch assembly. The touch assembly is constructed by a display and a touch sensing layer. Despite protection of the window film, after a period of operation, the touch assembly tends to be susceptive to an environmental effect, such as ultraviolet light. The environmental effect accelerates aging of the window film and the touch assembly. After long exposure to sunlight and wind and various types of operation habits of users, the window film is prone to damage and peel-off and the original protection function is either lessened or is even totally gone.

### SUMMARY OF THE INVENTION

An objective of the present invention is to provide a touch device with enhanced protection effect thereon capable of enhancing durability and operation cycle of the touch device.

To achieve the foregoing objective, the touch device with enhanced protection effect thereon includes a touch assembly, at least one protection layer, and a transparent layer.

The at least one protection layer is formed on the touch assembly and is made from a transparent and anti-ultraviolet material.

The transparent layer is formed on the at least one protection layer.

As can be seen from the foregoing structure of the touch device, the at least one protection layer is evenly painted on the touch assembly, and the transparent layer is formed on the at least one protection layer. The at least one protection layer is made from a transparent and anti-ultraviolet material. The transparent layer has a high hardness. Because the protection layer is sandwiched between the transparent layer and the touch assembly and is not susceptible to an aging effect arising from environmental factors, the durability and production yield of the touch device can be effectively enhanced.

Other objectives, advantages and novel features of the invention will become more apparent from the following detailed description when taken in conjunction with the accompanying drawings.

### BRIEF DESCRIPTION OF THE DRAWINGS

FIG. 1 is a schematic cross-sectional side view of a first embodiment of a touch device with enhanced protection effect thereon in accordance with the present invention;

FIG. 2 is a schematic cross-sectional side view of a second embodiment of a touch device with enhanced protection effect thereon in accordance with the present invention;

FIG. 3 is a schematic cross-sectional side view of the touch device in FIG. 2 when a transparent layer and a touch sensing layer are not formed on the touch device; and

FIG. 4 is a schematic cross-sectional side view of the touch device in FIG. 2 when a transparent layer and a touch sensing layer are formed on the touch device.

### DETAILED DESCRIPTION OF THE INVENTION

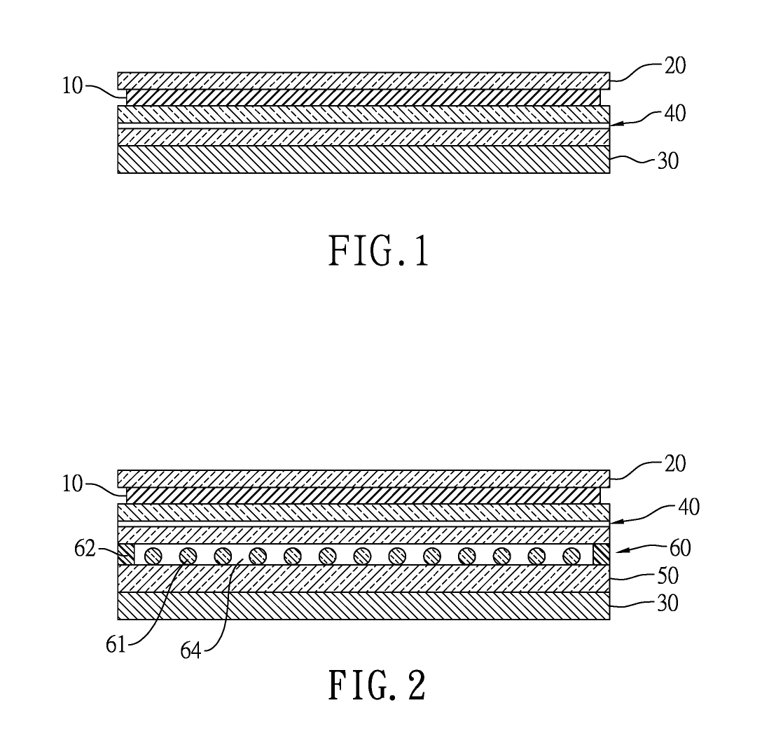

With reference to FIG. 1, a first embodiment of a touch device with enhanced protection effect thereon in accordance with the present invention includes a touch assembly, at least one protection layer 10, and a transparent layer 20. The at least one protection layer 10 is formed on the touch assembly. The transparent layer 20 is formed on the at least one protection layer 10. In the present embodiment, the touch assembly has a display 30 and a touch sensing layer 40. The touch sensing layer 40 is formed on the display 30, the at least one protection layer 10 is formed on the touch sensing layer 40, and the transparent layer 20 is bonded on the protection layer 10, such that the touch device can be constructed accordingly. The transparent layer 20 may be made of reinforced glass capable of transmitting light. The protection layer 10 may be formed by evenly painting a bonding agent mixed with titanium dioxide (TiO₂) nanoparticles or zinc oxide (ZnO) nanoparticles on the touch sensing layer 40. As the titanium dioxide nanoparticles or zinc oxide nanoparticles can absorb ultraviolet light, an aging effect caused by ultraviolet light on the touch device can be effectively reduced. The bonding agent is light-transmitting.

The protection layer 10 is a layered structure formed on the touch sensing layer 40. To enhance a protection effect of the protection layer 10, multiple protection layers 10 can be formed on the touch sensing layer 40. In the present embodiment, the thickness of each protection layer 10 is greater than or equal to 300 μm. Because the protection layer 10 is formed by the bonding agent, an elongation rate of each protection layer 10 is in a range of 200% to 300%. The protection layer 10 is used for the purpose of protection. When the protection layer 10 is operated at a room temperature 25° C., a tensile strength of the protection layer 10 at yield 200 mm/min can reach a range of 200 kg/cm² to 300 kg/cm².

With reference to FIG. 2, a second embodiment of a touch device with enhanced protection effect thereon in accordance with the present invention differs from the first embodiment in a transparent substrate 50 formed between the display 30 and the touch sensing layer 40 and a heat-shielding layer 60 formed between the transparent substrate 50 and the touch sensing layer 40. In the present embodiment, the transparent substrate 50 is formed by a glass substrate or a resilient material capable of transmitting light.

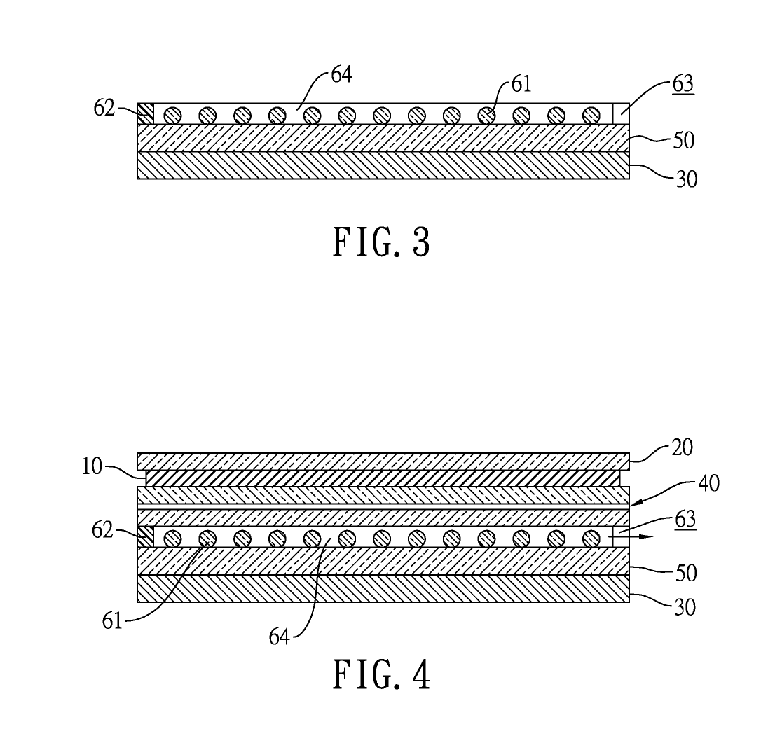

As to how the heat-shielding layer 60 is prepared, with respect to FIGS. 3 and 4, the transparent substrate 50 is formed on the display 30, a layer of polymer film is painted over the transparent substrate 50, and the heat-shielding layer 60 has multiple dot spacers 61 formed on the transparent substrate 50, evenly spaced apart from each other by gaps, and fabricated by forming the multiple dot spacers 61 inside the polymer film through a screen-printing process or a photolithography process. The multiple dot spacers 61 serve to enhance support capacity of the touch device. A portion of the polymer film not occupied by the multiple dot spacers 61 is etched to form an insulation space 64. Insulating adhesive 62 is pasted on a perimeter of the heat-shielding layer 60. An opening 63 is formed through the insulating adhesive at a portion on the perimeter of the heat-shielding layer 60 to communicate with the insulating space 64 in the heat-shielding layer 60 for the insulating space 64 to be vacuumed by a vacuum process via the opening 63. The insulating adhesive 62 is further filled in the insulating space 64 for the heat-shielding layer 60 to be vacuumed and heat-insulating. In the present embodiment, the multiple dot spacers 61 are made of a transparent material. The way of preparing the multiple dot spacers 61 in the present embodiment is applicable to large-size touch devices. In case of small-size touch devices, the multiple dot spacers 61 of the heat-shielding layer 60 are not necessarily prepared.

With further reference to FIGS. 2 and 4, an insulating space 64 in the heat-shielding layer 60 not occupied by the multiple dot spacers 61 is vacuumed by the vacuum process, such that the vacuumed insulating space 64 is filled with the insulating adhesive 62 through the opening 63 to form the heat-shielding layer 60 in a vacuum. The protection layer 10 is formed on the touch sensing layer 40 and the transparent layer 20 is formed on the protection layer 10.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A touch device with enhanced protection effect thereon, comprising:
a touch assembly;
at least one protection layer formed on the touch assembly and made from a transparent and anti-ultraviolet material; and
a transparent layer formed on the at least one protection layer;

2. The touch device as claimed in claim 1, wherein the touch assembly has a display and a touch sensing layer.

3. The touch device as claimed in claim 2, further comprising a transparent substrate formed between the display and the touch sensing layer.

4. The touch device as claimed in claim 3, further comprising a heat-shielding layer being vacuumed and heat-insulating, formed between the transparent substrate and the touch sensing layer and having an insulation space defined inside the heat-shielding layer, wherein insulating adhesive is pasted around a perimeter of the heat-shielding layer.

5. The touch device as claimed in claim 4, wherein
the heat-shielding layer further has multiple dot spacers formed inside the insulation space, evenly spaced apart from each other, and made of a transparent material; and
the insulation space is vacuumed by a vacuum process via an opening formed through a portion of the insulating adhesive and communicating with the insulation space, and the insulating adhesive is filled in the vacuumed insulating space for the heat-shielding layer to be vacuumed and heat-insulating.

6. The touch device as claimed in claim 5, wherein a thickness of each of the at least one protection layer is greater than or equal to 300 μm.

7. The touch device as claimed in claim 6, wherein the transparent layer is formed by reinforced glass capable of transmitting light.

8. The touch device as claimed in claim 7, wherein the transparent substrate is formed by a glass substrate or a transparent and resilient material.

9. The touch device as claimed in claim 7, wherein the at least one protection layer is formed by titanium dioxide (TiO₂) nanoparticles or zinc oxide (ZnO) nanoparticles.
